(19) United States
(12) Patent Application Publication
(10) Pub. No.: US 2007/0159017 A1
(43) Pub. Date: Jul. 12, 2007

(54) Explosion-proof motor with integrated sensor/lead housing

(76) Inventors: Jerry L. Martin, Gainesville, GA (US); Barron D. Grant, Gainesville, GA (US); Douglas Crumley, Gainesville, GA (US); Thomas S. Cufr, Gainesville, GA (US); John Kowaleski, Simpsonville, SC (US)

Correspondence Address: ROCKWELL AUTOMATION, INC./(FY), ATTENTION: SUSAN M. DONAHUE, E-7F19, 1201 SOUTH SECOND STREET, MILWAUKEE, WI, 53204, US

(21) Appl. No.: 11/329,795

(22) Filed: Jan. 11, 2006

(51) Int. Cl. H02K 5/10; H02K 1/06

(52) U.S. Cl. 310/88; 310/217

(57) ABSTRACT

A novel explosion-proof motor, which includes an integrated explosion-proof housing. In some embodiments, the integrated explosion-proof housing contains various electronic components that support the operation of the explosion-proof motor. To this end, embodiments of the explosion-proof motor may include a stator having an end ring, a plurality of stator coils extending from a core, and an end bracket fitted to the stator end ring to form a generally circumferential flame path. The end bracket may include an inner volume on one side thereof for receiving the stator coils, and an integrated explosion-proof housing on the other side. To reduce the number of explosion-proof seals, the inner volume and integrated explosion-proof housing may share the circumferential flame path to enclose their respective volumes.

### BACKGROUND

The invention relates generally to electric motors. More specifically, the invention relates to a housing for an explosion-proof electric motor.

Often, electric motors operate in an explosive environment. For example, electric motors power machinery in and near coal mines, where coal dust and methane are often concentrated. Similarly, electric motors operate in explosive environments in grain silos with explosive grain dust and in chemical plants processing volatile chemicals.

Typically, industrial standard “explosion-proof” motors are employed in such explosive environments. Generally, an explosion-proof motor includes a housing constructed to withstand a discharge or ignition within the housing and, should such an event occur, prevents the ignition of materials surrounding the housing. The explosion-proof motor housing often includes sealed joints that serve two functions. First, the sealed joints may prevent hot exhaust gas or flame produced by the internal ignition from escaping the housing. Second, the sealed joints channel those hot gases or flame that do escape over a distance to lower the temperature of the gas or flame before it reaches the surrounding environment. By cooling and containing hot gases within the motor, the housing may prevent an internal spark or ignition from spreading to the surrounding environment.

While various electronic and electrical components are increasingly added to other motors, it is unfortunately expensive and complicated to add electronic components to explosion-proof motors. Generally, a separate explosion-proof housing contains electronic components added to such motors. The separate explosion-proof housing reduces the risk of one of the electronic components igniting surrounding combustible materials. However, a separate explosion-proof housing consumes scarce space near the electric motor, and the sealed joints associated with such explosion-proof housings often include tight tolerances that may be expensive to manufacture.

Accordingly, there is a need for an explosion-proof motor that accommodates supporting electronic components within an integrated explosion-proof housing.

### BRIEF DESCRIPTION

The present invention provides, in certain embodiments, a novel explosion-proof motor. The explosion-proof motor may include an integrated explosion-proof housing. In some embodiments, the integrated explosion-proof housing contains various electronic components that support the operation of the explosion-proof motor. To this end, embodiments of the explosion-proof motor may include a stator having an end ring, a plurality of stator coils extending from a core, and an end bracket fitted to the stator end ring to form a generally circumferential flame path. The end bracket may include an inner volume on one side thereof for receiving the stator coils, and an integrated explosion-proof housing on the other side. To reduce the number of explosion-proof seals, the inner volume and integrated explosion-proof housing may share the circumferential flame path to enclose their respective volumes.

### DRAWINGS

These and other features, aspects, and advantages of the present invention will become better understood when the following detailed description is read with reference to the accompanying drawings in which like characters represent like parts throughout the drawings, wherein:

FIG. 1 is a side profile view of an exemplary explosion-proof motor in accordance with embodiments of the present techniques;

FIG. 2 is a cross-sectioned side view of the explosion-proof motor of FIG. 1;

FIG. 3 is a cross-sectioned side view of an end bracket for the explosion-proof motor of FIGS. 1 and 2;

FIG. 4 is an enlarged view of a portion of the cross-section of FIG. 2, illustrating a flame path in accordance with embodiments of the present techniques;

FIG. 5 is a front perspective view of an end bracket of the type shown in FIG. 2; and

FIG. 6 is a rear perspective view of an end bracket of the type shown in FIG. 2.

### DETAILED DESCRIPTION

The following discussion describes an explosion-proof motor that, in certain embodiments, includes various electronic components and electrical connections within a single integrated explosion-proof housing. Advantageously, as is described in greater detail below, certain embodiments house a motor, electronic component, and various electrical connections within a relatively compact volume. Moreover, certain embodiments include two volumes within a single integrated housing: one volume housing a motor and the other volume housing electronic components and electrical connections.

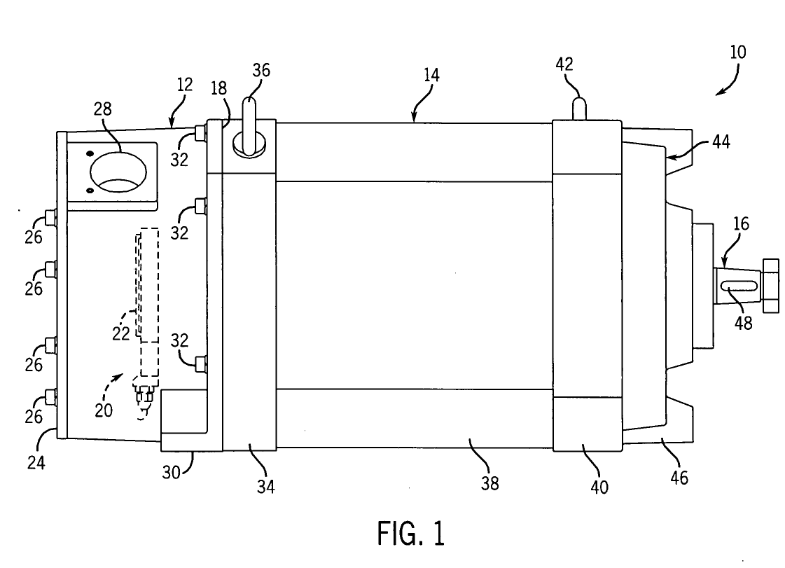

FIG. 1 illustrates an exemplary explosion-proof motor 10 that is manufactured in accordance with embodiments of the present techniques. As is described in greater detail below, the explosion-proof motor 10 includes a front end bracket 12 that integrally houses both a portion of the motor 10 and various electronic components. The illustrated explosion-proof motor 10 includes an alternating current induction motor. However, in other embodiments within the scope of the present technique, the explosion-proof motor 10 may include a direct current motor, a brushless direct current motor, a servo motor, a brushless direct current servo motor, a brushless alternating current servo motor, a stepper motor, or a linear motor, for example.

The illustrated explosion-proof motor 10 includes the front end bracket 12, a stator 14, a rotor and shaft assembly 16, and a flame path 18. The illustrated front end bracket 12 encloses one end of the stator 14 and rotationally supports the shaft 16. When energized, the stator 14 cooperates with the rotor 16 to convert electrical energy into mechanical energy. The junction of the front end bracket 12 and the stator 14 forms the flame path 18, which is described in greater detail below.

As used herein, the term “flame path” refers to a joint between two components of a motor housing that satisfy certain standards pertaining to explosion-proof motors. For example, the joint may satisfy the requirements promulgated by the Underwriters Laboratories for class I explosion-proof motors or class II explosion-proof motors. In other words, the term “flame path” refers to a junction between two components in a motor housing that is sufficiently tight and sufficiently long that an ignition event within the motor housing is unlikely to propagate to the surrounding environment.

The exemplary front end bracket 12 includes various features that support the operation of the explosion-proof motor 10. For example, the present front end bracket 12 partially encloses an outer volume 20 that contains an encoder 22. Alternatively, or additionally, the outer volume 20 or other portions of the front end bracket 12 may contain a drive, a contactor, a terminal board, a control device, and/or a brake, for example. A cover 24 coupled to the front end bracket 12 encloses the outer volume 20. Cover fasteners 26 secure the cover 24 to the front end bracket 12. The illustrated cover fasteners 26 include bolts fitted into threaded apertures, but other embodiments in accordance with the present techniques may include other types of fasteners 26, such as a welded joint, rivets, or snap rings, for example. The illustrated front end bracket 12 also includes a cable outlet 28. Various leads or cables that support the operation of the motor may pass through the cable outlet 28, for instance power leads and communication cables. Front supports 30 extending from the front end bracket 12 may secure the explosion-proof motor 10 to a larger chassis or piece of equipment. The illustrated front end bracket 12 couples to the stator 14 through an array of bracket fasteners 32. The illustrated bracket fasteners 32 include circumferentially disposed bolts fitted within threaded apertures. However, in other embodiments, other forms of fasteners, such as those listed above, may be employed.

The exemplary stator 14 features a front end ring 34, an eye bolt 36, a core 38, a back end ring 40, and an eye bolt 42. As is described in greater detail below, the front end ring 34 and the back end ring 40 may cooperate to compress the core 38. Eye bolts 36 and 42 couple to the front end ring 34 and the back end ring 40 respectively and may facilitate movement of the explosion-proof motor 10. The illustrated front end ring 34 affixes to the front end bracket 12, and the junction between these two components 12 and 34 forms the flame path 18.

A back end bracket 44 encloses one end of the stator 14 and supports various functions of the explosion-proof motor 10. The back end bracket 44 couples to the back end ring 40. Back supports 46 extending from the bottom of the back end bracket 44 may cooperate with the front supports 30 to secure the explosion-proof motor 10 to a machine frame. The back end bracket 44 and the front end bracket 12 enclose opposing ends of the stator 14 and rotatably support the rotor and shaft assembly 16.

The illustrated rotor and shaft assembly 16 rotates within the stator 14 and transfers mechanical energy out of the explosion-proof motor 10. To this end, the assembly shaft includes a keyway 48 to secure the shaft to other rotating members. Of course, other techniques to secure the shaft 16 to rotating members may be employed in accordance with the present techniques, such as a spline, a force fit bushing or a direct drive, for example.

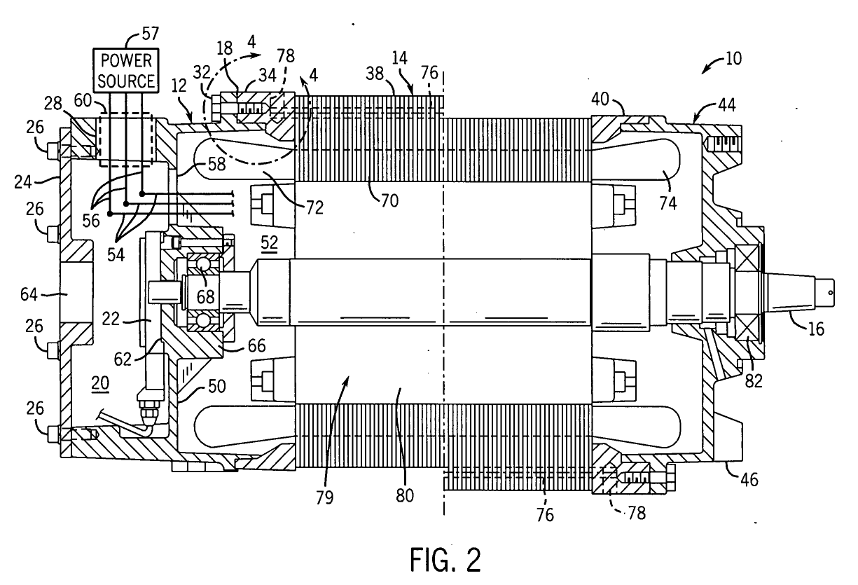

FIG. 2 illustrates the interior of the explosion-proof motor 10 in a cross-sectional view. Returning to the front end bracket 12, an interior wall 50 separates the outer volume 20 from an inner volume 52. As is described in greater detail below, the inner volume 52 partially houses various moving parts within the explosion-proof motor 10.

In addition to the encoder 22, the outer volume 20 houses several components that deliver power to the explosion-proof motor 10. Stator leads 54 pass from the inner volume 52, through the interior wall 50, and into the outer volume 20. The stator leads 54 conduct electrical power to various subsequently discussed windings within the explosion-proof motor 10. For example, the stator leads 54 may deliver three-phase alternating current power. The illustrated stator leads 54 pass through an inner wall aperture 58 in the interior wall 50. Thus, the inner volume 52 is in communication with the outer volume 20 through the inner wall aperture 58. In the illustrated embodiment, power leads 56 conduct electricity from a power source 57 into the outer volume 20 by connection to the stator leads 54 in the outer volume 20. Advantageously, the stator leads 54 connect to the power leads 56 within the front end bracket 12, thereby avoiding the need for a separate explosion-proof housing to contain these connections. However, in other embodiments, the power leads 56 may connect to the stator leads 54 elsewhere within the explosion-proof motor 10, such as within the inner volume 52, or outside the explosion-proof motor 10. In the present embodiment, a packing gland 60 seals the cable outlet 28 while permitting the power leads 56 to exit the front end bracket 12. The illustrated cover 24 includes an alternate cable outlet 64 that may be sealed when not in use.

Additionally, the front end bracket 12 includes an encoder support 62 on the interior wall 50. The illustrated encoder support 62 resides on the side of the interior wall 50 adjacent the outer volume 20, but, in other embodiments in accordance with the present techniques, the encoder support 62 may be disposed elsewhere within the outer volume 20, in the inner volume 52, or external to the explosion-proof motor 10, for example.

The exemplary interior wall 50 includes a bearing support 66 on the side of the interior wall 50 adjacent the inner volume 52. The illustrated bearing support 66 supports bearing 68, which, in turn, rotatably supports the rotor and shaft assembly 16. Of course, in other embodiments, the bearing support 66 may be disposed on the opposing side of the interior wall 50 or the cover 24, for example.

The illustrated stator 14 features a stator coil 70 with a front head 72 and a rear head 74. The stator coil 70 includes a plurality of windings in any suitable winding pattern, defining poles and groups in a manner generally known in the art. When these windings conduct an electric current, they generate an electromagnetic field that drives the rotation of the shaft 16. The front head 72 of the illustrated stator coil 70 reaches into the inner volume 52 of the front end bracket 12, and the rear head 74 reaches into a volume enclosed by the back end bracket 44.

In the present embodiment, the core 38 is pre-compressed by tensile members. A number of rod apertures 76 in the core 38, and a number of weld access apertures 78 in the front end ring 34 and the back end ring 40 house the tensile members that tie the stator 14 together. The rod apertures 76 extend through the core 38, from the front end ring 34 to the back end ring 40. The rod apertures 76 align with the weld access apertures 78, so that a tensile member threaded through the rod apertures 76 extends into the weld access apertures 78. To tie the stator 14 together, tensile members are welded to the front end ring 34 and to the back end ring 40 within the weld apertures 78. However, before the tensile members are welded, the core 38 is externally pre-compressed, thereby placing the tensile members in tension and leaving the core 38 compressed when the external pressure is removed. It should be noted that other techniques may be used for maintaining the stator or frame elements as a tight unit, such as threaded tie rods, external welds, and so forth.

The stator 14 encircles a generally cylindrical interior volume 79 that holds a rotor 80. The rotor 80 may include permanent magnets or electromagnets that cooperate with electromagnetic fields generated by the stator coil 70 to rotate the shaft 16. A bearing 82 supported by the back end bracket 44 cooperates with the bearing 68 to rotatably support the rotor and shaft assembly 16.

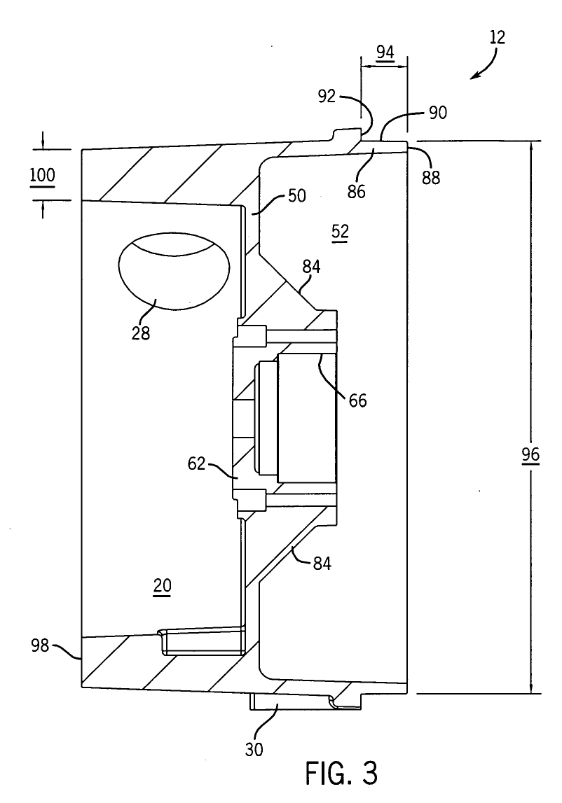

FIG. 3 illustrates additional features of the front end bracket 12 with a cross-sectional view. The present front end bracket 12 includes ribs 84 and an end bracket extension 86. The ribs 84, which stabilize the bearing support 66, are circumferentially disposed about the bearing support 66. The illustrated end bracket extension 86 is an annular member extending from the front end bracket 12 around the interior volume 52.

The end bracket extension 86 may include a several surfaces that interface with the front end ring 34 to form flame path 18. For instance, the illustrated end bracket extension 86 includes a forward surface 88, an outer diameter surface 90, and a rear surface 92. In the current embodiment, the forward surface 88 and rear surface 92 generally fall within parallel planes. The illustrated outer diameter surface 90 extends orthogonally between these planes. In other words, the intersection of the outer diameter surface 90 with the forward surface 88 and the rear surface 92 generally forms right angles. The outer diameter surface 90 extends through a tubular width 94 between the front surface 88 and the rear surface 92, and the outer diameter surface 90 generally traces the perimeter of a circle with an outer diameter 96. In certain embodiments, the tubular width 94 may range from 1.24 to 1.26 inches, 1.23 to 1.27 inches, 1.22 to 1.28 inches, 1.21 to 1.29 inches, 1.20 to 1.30 inches, 1.15 to 1.35 inches, 1.10 to 1.40 inches, 1.05 to 1.45 inches, 1.00 to 1.50 inches, 0.50 to 2.00 inches, or 0.25 to 2.25 inches, for example. Similarly, in various embodiment, the outer diameter 96 may range from 14.00 to 16.00 inches and have a tolerance of less than 0.001 inches, 0.002 inches, 0.003 inches, 0.004 inches, 0.005 inches, 0.01 inches, 0.05 inches, or 0.10 inches, for instance.

The exemplary front end bracket 12 includes a cap contact surface 98 with a cap contact width 100. The present cap contact surface 98 contacts the cover 24 and seals the outer volume 20. The cap contact width 100 may range, in various embodiments, from 1.37 to 1.39 inches, 1.36 to 1.40 inches, 1.35 to 1.41 inches, 1.34 to 1.42 inches, 1.33 to 1.43 inches, 1.00 to 2.00 inches, or 0.50 to 2.50 inches, for example. The illustrated cap contact surface 98 generally lies within a plane. However, in other embodiments, the cap contact surface 98 may be non-planar (e.g., curved or undulating).

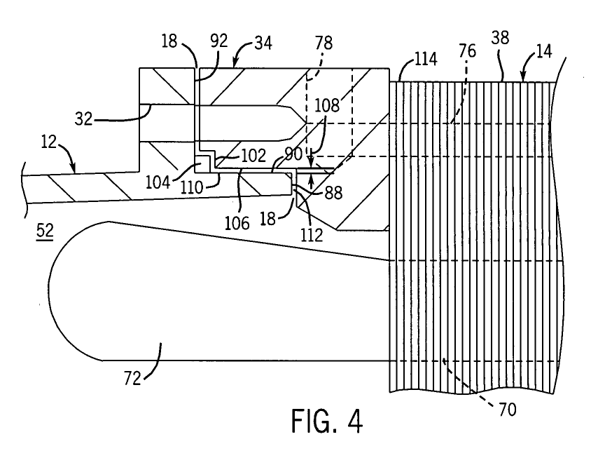

FIG. 4 depicts view of a flame path 18, which, in the present embodiment, is the gap between the adjacent portions of the front end bracket 12 and the front end ring 34. The exemplary front end ring 34 includes an inner diameter surface 106 that mates with the outer diameter surface 90 of the end bracket extension 86. That is, the front end ring 34 forms a bushing around the end bracket extension 86. The flame path 18 has a flame path width 108, which is the distance between the inner diameter surface 106 of the front end ring 34 and the outer diameter surface 90 of the end bracket extension 86. In certain embodiments, the flame path width 108 may range from 0.003-0.005 inches, 0.002-0.006 inches, 0.001-0.007 inches, 0.000-0.008 inches, or 0.000-0.050 inches, for example. Alternatively, the front end bracket 12 and the front end ring 34 may be joined by an interference or a transition fit. The illustrated flame path 18 includes a tubular portion 110 and an annular portion 112. The tubular portion 110 is generally orthogonal to the annular portion 112. As will be appreciated, other embodiments in accordance with the present technique may include a flame path 18 without an annular portion 112, a tubular portion 110, or both. Additionally, some embodiments may include multiple concentric tubular portions 110 and/or multiple annular portions 112. Advantageously, in the event of an internal discharge, hot exhaust gases or flames escaping from the explosion-proof motor 10 change direction when passing from the annular portion 112 to the tubular portion 110, thereby potentially further cooling the hot gases or flames.

Also illustrated by FIG. 4, the front end ring 34 includes an annular notch 102 that houses a seal 104. The notch 102 and seal 104 cooperate with the flame path 18 to contain and cool hot gases or flames resulting from a discharge within the explosion-proof motor 10. Of course, other embodiments in accordance with the present techniques may employ multiple seals 104 or no seals 104.

A plurality of stacked laminations 114 form the core 38. These laminations 114 may include various features to prevent hot gases or flames from escaping between the laminations 114, such as a cold worked or peened finish. In general, a flame path is also defined between each pair of adjacent laminations 114. However, these flame paths are longer than flame path 16 described above, making the latter the favored path for the escape of gases or flames in the event of a discharge within the motor.

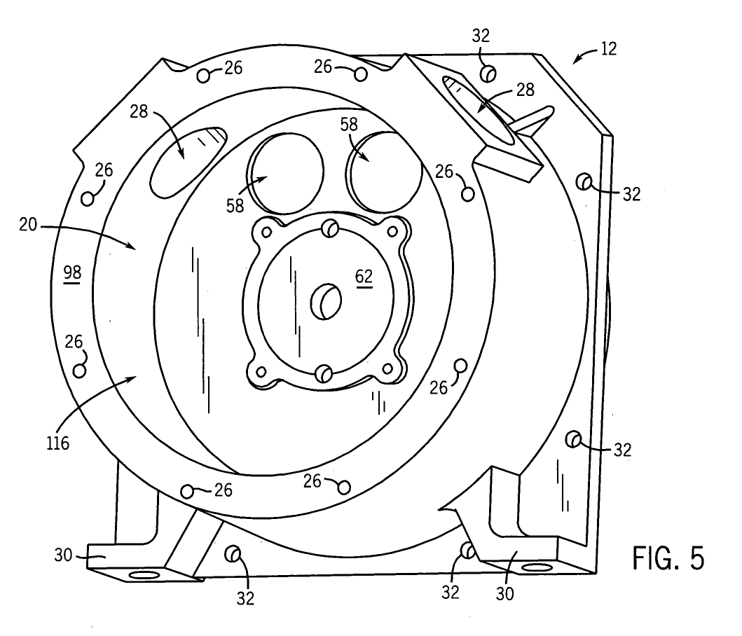

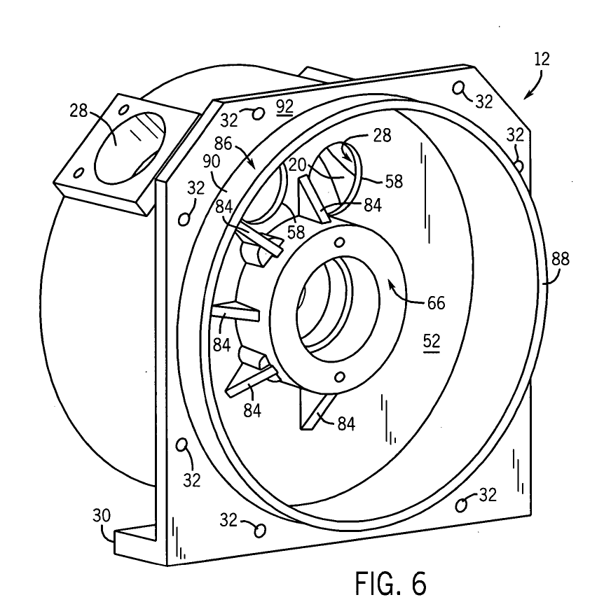

FIGS. 5 and 6 respectively illustrate front and rear perspective views of a front end bracket 12 in accordance with embodiments of the present techniques. The illustrated front end bracket 12 includes two cable outlets 28 and two inner wall apertures 58. FIG. 5 illustrates an open side 116 of the front end bracket 12. In operation, the cover 24 seals the open side 116 of the front end bracket 12. Advantageously, the cover 24 may be removed and connections or components within the outer volume 20 may be easily accessed.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An alternating current, explosion-proof motor comprising:
a stator having an end ring and a plurality of stator coils extending from a core;
an end bracket fitted to the stator end ring to form a generally circumferential flame path therebetween, the end bracket including an inner volume on one side thereof for receiving the stator coils, and an outer volume on another side thereof, the inner and outer volumes being contiguous and sharing the circumferential flame path to enclose the inner and outer volumes.

2. The motor of claim 1, wherein the end bracket includes an interior wall separating the inner and outer volumes, the interior wall including a bearing support for supporting a rotor of the motor in rotation.

3. The motor of claim 1, wherein the end bracket includes an interior wall separating the inner and outer volumes, the interior wall including an encoder support for receiving an encoder disposed within the outer volume.

4. The motor of claim 1, wherein the circumferential flame path is formed between a radially outer surface of the end ring and a radially inner surface of an extension of the end bracket.

5. The motor of claim 1, wherein the circumferential flame path includes a sealing member.

6. The motor of claim 1, wherein the outer volume of the end bracket includes an open side providing access to the outer volume, and the end bracket is configured to receive a cover for sealingly covering the open side.

7. The motor of claim 1, wherein the stator coils are electrically coupled to a source of power via leads disposed in the outer volume.

8. The motor of claim 1, further comprising an electrical device disposed in the outer volume.

9. The motor of claim 8, wherein the electrical device is an encoder.

10. An alternating current, explosion-proof motor comprising:
a stator having an end ring and a plurality of stator coils extending from a core;
a rotor rotatably disposed within the stator;
an end bracket fitted to the stator end ring to form a flame path therebetween, the end bracket including an inner volume and an outer volume separated by an interior wall, the interior wall includes an opening, whereby the outer volume is part of the same internal explosion-proof volume with the inner volume, the interior wall including a bearing support for the rotor; and
an encoder supported on the interior wall of the end bracket and coupled to the rotor through the interior wall.

11. The motor of claim 10, wherein the flame path is a generally circumferential path defined between an extension of the end ring and a mating extension of the end bracket.

12. The motor of claim 11, wherein the circumferential flame path is formed between a radially outer surface of the end ring and a radially inner surface of an extension of the end bracket.

13. The motor of claim 11, wherein the circumferential flame path includes a sealing member.

14. The motor of claim 10, wherein the stator coils are electrically coupled to a source of power via leads disposed in the outer volume.

15. An explosion-proof motor comprising:
a frame having an end ring; and
an end bracket fitted to the frame end ring to form a generally circumferential flame path therebetween, the end bracket an interior wall between an inner volume on one side thereof open to an interior of the frame, and an outer volume on another side thereof, the inner and outer volumes being contiguous through an opening in the interior wall and sharing the circumferential flame path to enclose the inner and outer volumes.

16. The motor of claim 15, wherein the frame has a plurality of frame coils extending from a core.

17. The motor of claim 15, comprising an encoder coupled to the interior wall and disposed at least partially in the outer volume.

18. The motor of claim 15, wherein the interior wall includes a bearing support disposed at least partially in the inner volume.

19. The motor of claim 15, wherein the circumferential flame path includes a generally tubular portion and a generally annular portion.

20. The motor of claim 15, wherein the end bracket is a single piece of material.
